(19) United States
(12) Patent Application Publication
(10) Pub. No.: US 2025/0316917 A1
(43) Pub. Date: Oct. 9, 2025

(54) PLUG-IN CONNECTOR FOR ELECTRICALLY CONNECTING TWO PRINTED CIRCUIT BOARDS

(71) Applicant: Webasto SE, Stockdorf (DE)

(72) Inventors: Fabian RIEDIGER, Stockdorf (DE); Peter WITTICH, Stockdorf (DE); Rainer STAUDE, Stockdorf (DE); Christian KNOP, Stockdorf (DE)

(21) Appl. No.: 19/095,312

(22) Filed: Mar. 31, 2025

(30) Foreign Application Priority Data
Apr. 5, 2024 (DE) 102024203140.2

(51) Int. Cl. H01R 12/73

(52) U.S. Cl. CPC H01R 12/732; H01R 2201/26

(57) ABSTRACT

A plug-in connector for electrically connecting two printed circuit boards includes first and second mechanically interacting connection parts. The first connection part comprises a first base section that has a first bottom wall with a first lower surface for attachment to a first printed circuit board, and a first spring section, which comprises two resiliently mounted first wall sections lying opposite each other in a second direction. The second connection part comprises a second base section that has a second bottom wall with a second lower surface for attachment to a first printed circuit board, and a second spring section, which comprises two resiliently mounted second wall sections. The first and the second wall sections each comprise first and second contact sections, which are designed to interact, so that contact defined by the contact sections in the latched-in state has space in the first direction.

### CROSS-REFERENCE TO RELATED APPLICATION(S)

This application claims the benefit of German Application No. DE 10 2024 203 140.2, filed Apr. 5, 2024, which is incorporated herein by reference in its entirety.

### TECHNICAL FIELD

Various aspects relate to a plug-in connector for connecting two, for example strip-like, printed circuit boards. In particular, some aspects relate to plug-in connectors of flexible LED strips for ambient light illumination in glass roofs or for connection to switchable glass panes in vehicles.

### BACKGROUND

LED strips are used, for example, in roof systems of vehicles in order to be able to achieve desired indirect lighting and/or various visual effects. The LED strip may be a more or less flexible, but in particular rigid-flexible (FR-4 circuit board, for example in combination with interposed polyimide films), carrier material which acts as printed circuit boards and on which arrangements of LEDs are positioned in a wired manner and are operated by drivers/control devices likewise provided there. Such LED strips are also used in order to create atmospheric light scenarios, which are also referred to as “ambient light” in transparent roof elements of vehicles, in particular motor vehicles etc. The lighting elements corresponding to the LED strips can be integrated into the roof system, for example in the edge region of the transparent roof element or glass cover. Here, the light is coupled laterally, for example via prisms, into suitable pane planes of the roof system, so that optical structures introduced into the glass pane scatter the light and as a result become visible to the vehicle occupants.

In such a use, only very tight installation space is typically available for the LED strips. The height of the installation space perpendicular to the glass surface may be, for example, only 1.9 to 2 mm. A height of the printed circuit board of the LED strip may already be, for example, 0.8-1 mm. The flat strips also have to follow the curvature or curves of the installation space in the roof region. The LED strips are supplied with power and also controlled (via a bus, for example an LIN bus) via a cable harness, the cable harness plug of which is brought into contact with a plug-in connector (so-called header) in the region of the LED strips. The LED strips can extend over an entire length of the glass cover in the frame region. However, this length may considerably exceed a length of the LED strips, and therefore several modules are often plugged together. A plug-in direction parallel to the plane of the printed circuit board is customary here.

For installation in the installation space, the previously assembled modules or LED strips are mounted, for example jointly in a direction perpendicular to the printed circuit board surface, onto the prisms and therefore onto the glass cover (pane) in a subsequent step. They are positioned, inter alia, by positioning pins, which are formed on the glass cover in the region of the prisms and extend perpendicularly to the glass surface and therefore also perpendicularly to the printed circuit board plane. During assembly, these positioning pins are inserted into positioning openings, which are provided in the printed circuit boards of the LED strip. The LED strips mounted onto the prisms as a consequence can then generally no longer be moved in a longitudinal direction parallel to the printed circuit board plane and the plug-in direction in situ in the roof system-owing to the low installation space height.

The consequence may be, under certain circumstances, significant restrictions for mounting or exchanging modules. Specifically in this case, these modules can barely still be joined to the currently available plug-in connectors on account of the small installation space on the glass cover in the roof system of the vehicle itself and also cannot be individually exchanged either if this is necessary after a period of use, for example if a light source fails or in the case of degradation.

LED strips are generally coupled in the longitudinal direction of the printed circuit boards each lying opposite each other at their end faces. The use of SMT plug-in connectors is customary for coupling (SMT: Surface Mounted Technology, also SMD: Surface Mounted Devices). Connection parts, which can be mechanically coupled to each other in this case, of the SMT connectors can be soldered or bonded onto conductor track pads, which are pushed one into the other and latch one into the other during assembly, on both sides. An example can be found in the datasheet of Kyocera SMT connector 70-9159-001-401/402-006. This is a KYOCERA AVX Series 9159 board-to-board plug-in connector system which is used especially in the field of solid state lighting (SSL) and allows pairing of printed circuit boards in one plane (horizontal-horizontal). These SMT plug-in connectors allow the gap to be minimized and boards to be connected edge-to-edge, although a tolerance field is also potentially possible. The plug-in connector system comprises two connection parts, which can be pushed linearly one into the other. However, these add a further 1.2 mm to the overall height of the printed circuit board structure in addition to the printed circuit board thickness, so that the structure and the installation space height are already of similar dimensions, that is to say approximately 2 mm. Therefore, such a plug-in connector system is likewise subject to the above-described restrictions in the tight, in particular flat, installation space.

Proceeding from known plug-in connector systems of the described type, there is therefore a need for a plug-in connector which solves the abovementioned problems and, in particular, allows the modules to be joined to each other and also released from each other in situ in the roof system of a vehicle.

Document WO 2011/025534 A1 discloses a plug-in connector assembly for two printed circuit boards fitted with LEDs, for example. Each plug-in connector assembly comprises a first contact module and a second contact module, which are electrically connected to each other. The electrically conductive parts are each accommodated in a module housing which, in the case of the first contact module, is positioned on the first printed circuit board in a manner somewhat set-back from an edge and which, in the case of the second contact module, is positioned on the second printed circuit board in a manner slightly protruding at its edge, as a result of which vertical orientation with each other is achieved during connection. The first contact module provides a socket and the second contact module provides a plug which is received in the socket. The housing of one module comprises a receiving space which receives a portion of the second contact module. The contacts are U-shaped and positioned in the receiving space in order to receive, in particular, a contact of the other contact module. This contact of the other contact module extends outward from the front face of the corresponding module housing. These contacts represent blade- or pin-like contacts which are configured such that they can be inserted into the receiving space and the U-shaped contacts of the first module housing in the vertical or horizontal direction. The contacts of the two modules have mutually facing projections, so that the electrical contact between the projections is established.

### SUMMARY

Aspects of the invention that meet the abovementioned need relate to a plug-in connector for electrically connecting two printed circuit boards lying with their end faces opposite each other. The plug-in connector comprises a first connection part and a second connection part, which mechanically interacts with the first connection part, for establishing the electrical connection. The first connection part can be provided for attachment to a first printed circuit board and the second connection part can be provided for attachment to a second printed circuit board, specifically advantageously close to opposite end-face edges of the two printed circuit boards in order to allow mutual engagement and connection of the two connection parts. The two connection parts are each preferably formed in one piece and from electrically conductive material, for example a metal, such as a copper alloy. The latter can be entirely or partially surface-treated or -coated. The printed circuit boards may be flexible LED strips, but may well also be other circuit boards, for example rigid printed circuit boards with a substrate composed of FR-4 material. In accordance with non-limiting exemplary embodiments, the proposed plug-in connectors can be arranged on printed circuit boards which comprise a rigid-flexible material, in particular a combination of FR-4 composite material layers and polyimide films. Since aspects of the invention are particularly directed at use in tight installation spaces, plug-in connectors are preferred for printed circuit boards or printed circuit board assemblies in vehicles, in particular in roof systems of motor vehicles. Here, vehicles are also understood to mean trucks, construction machines, ships, aircraft or spacecraft.

The first connection part and the second connection part are preferably formed from the same material. A subsequently applied insulation or an insulation in the form of a housing is not excluded. In accordance with aspects, the first connection part and the second connection part have a similar basic design:

The first connection part comprises a first base section and a first spring section. The base section serves for attachment to the relevant printed circuit board and to provide a stable design, while the spring section serves to establish secure mechanical and electrical contact. The first base section has a first bottom wall with a first lower surface, which spans a plane (XY plane), for attachment, in particular soldering, to a first main surface area of a first of the two printed circuit boards. Other cohesive, force-fitting or interlocking joining techniques, for example bonding or adhesive bonding using electrically conductive materials, can also be employed instead of soldering. The first lower surface (or else also the entire component) may be coated with gold (for example plating).

In the case of attachment on the relevant first printed circuit board, said plane corresponds to the main surface area of the first printed circuit board (in the case of flexible printed circuit boards, only one planar local surrounding area at the end face is taken into consideration here). The plane is defined by a first direction (X direction), in which the two printed circuit boards lie with their end faces opposite each other in the connected state, and a second direction (Y direction), which is perpendicular to the first direction. In the case of LED strips, the X direction generally corresponds to the longitudinal direction of the LED strips. The first spring section comprises two resiliently mounted first wall sections lying opposite each other in the second direction (Y).

The second connection part analogously comprises a second base section and a second spring section. The second base section has a second bottom wall with a second lower surface, which spans the same plane (XY plane) in the installed state, for attachment, in particular soldering, to a second main surface area of the corresponding second printed circuit board. Here, the first spring section also comprises two resiliently mounted second wall sections lying opposite each other in the second direction (Y direction).

With regard to the two connection parts, the resiliently mounted first wall sections are now configured to receive between them the resiliently mounted second wall sections along a third direction (Z direction), which lies perpendicular to the plane (XY plane). This means, in particular, that the mutual spacings of the wall sections in the first connection part and the second connection part in the second direction (Y direction) are adapted such that the two second wall sections fit between the two first wall sections. A deflection (spring tension) of the wall sections (of the first wall sections in the Y direction outward and/or of the second wall sections in the Y direction inward) required for this purpose can be absorbed here. The first connection part can thus be referred to as a female part and the second connection part as a male part. The fact that the insertion direction can lie in particular in the third direction here, that is to say the Z direction perpendicular for example to the main surface area of the two printed circuit boards, does not prevent insertion of the second wall sections also optionally being able to take place along the first direction (the X direction). In accordance with exemplary embodiments, the second wall sections can in particular also be inserted along a combination of the Z and the X direction, that is to say from an inclined spatial direction. In principle, the entire XZ plane is optionally available for inserting the second wall sections into the first wall sections. As described in the introductory part, a tight installation space and the fact that the printed circuit boards are already fixed in the X direction may mean that only the Z direction is available for joining.

Furthermore, it should be noted that aspects of the invention allow a greater tolerance for the insertion direction. Therefore, it is also possible to establish the connection from spatial directions that are inclined with respect to the XZ plane.

In accordance with aspects according to the invention, the first wall sections each comprise a first contact section and the second wall sections each comprise a second contact section. A respective one of the first contact sections is designed to interact with a corresponding one of the second contact sections when the two connection parts are connected by mutual latching. This may mean, for example, that, when the second wall sections are received between the first wall sections, initially a spring deflection of the resiliently mounted first wall sections outward and/or a spring deflection of the resiliently mounted second wall sections inward takes place (because the wall spacings are correspondingly dimensioned), after which mechanical load relief occurs when the contact sections meet within the wall sections. Owing to the mechanical load relief, one contact section latches into the opposite contact section, so that stable mechanical contact and thus fixing of the opposite wall sections is achieved. The wall sections thus remain in position or a force is required in order to release the connection again.

It should be noted that at least one of the connection parts may be arranged, in particular, on a printed circuit board, in particular a flexible circuit board (FPCB) of an LED bar, such as an LED strip, and can be connected to a conductor track there.

Aspects of the invention then allow for the first contact sections and the second contact sections to exhibit a different extent from each other in the first direction (X direction), so that contact defined by the contact sections in the latched-in state has space in the first direction (X direction).

This space, which is present on the sides of the two contact pairs of resiliently mounted wall sections, then allows the connection parts lying opposite each other in the case of the connection in the first direction (X direction) to exhibit a tolerance in the mutual orientation. In particular, during joining, which is performed for example in the third direction (Z direction), one connection part can be oriented at an angle inclined with respect to the X direction within the XY plane (if it is assumed for example that the other connection part is positioned exactly along the X direction). In this connection part, the positions of the contact sections of one connection part projected onto the X direction are different owing to the inclined orientation, but this is compensated for by the contact sections extended on one side in the X direction since the opposite contact section is displaceable within these contact sections, without the latched-in connection having to be released.

In the case of a larger angle of the mutual orientation, the wall sections that make contact with each other are additionally spread apart, so that the corresponding spring tension is also increased. As a result, under certain circumstances, a force can act on the two connection parts, both of which are again pushed along the first direction (X direction) with a rectilinear orientation. The features according to the invention can therefore even lead to self-adjustment.

This tolerance for the mutual orientation in the XY plane can be temporarily used during joining in order to make this process more tolerant to faults, or it can be used to allow connection of printed circuit boards that permanently allows an angle in the mutual in-situ orientation and thus increases the flexibility in assembly design.

A further advantage is that, in particular when the connection parts are joined in the third direction (Z direction), efficient meeting of the contact sections may be improved. Since the extent of one of the contact sections in the X direction is extended, the probability of the contact sections finding each other as they approach each other in the Z direction during the joining operation is then also increased. The joining process is therefore not only provided with a greater tolerance, but is also more reliable and more efficient overall.

Therefore, overall, the proposed plug-in connection creates the possibility of providing the joining direction parallel to a mounting direction if, for example, the printed circuit boards are those of modules of an LED strip that are attached to a glass cover of a vehicle roof. In this case, even when the LED modules are mounted and as a result can no longer be moved in the longitudinal direction (“X direction”) as described in the introductory part because they are more or less fixed in this direction by positioning holes which interact with associated positioning pins on the glass cover when orienting the LEDs opposite light incoupling prisms, a single module can be disconnected and released from the module to which it was previously connected, in order to exchange it, for example. This can be done in situ in the limited space in the roof system, that is to say the glass cover or other components do not need to be removed from the roof for this purpose, for example.

The tolerance improved by the aspects according to the invention in combination with the possible joining direction perpendicular to the printed circuit board plane (in the Z direction) may assist in particular the described application situation in the roof system of vehicles: the preferably strip-like printed circuit boards can be mounted and fixed on the glass cover in the vehicle roof in the positions defined by the positioning pins and prisms in the case of ambient light illumination. A mutual mechanical connection is therefore only important for ensuring reliable electrical connection, while the mutual spatial positioning is already roughly in place. This allows tolerances and less stringent requirements with respect to mechanical loads which would be present if the strips were laid freely and without fastening. The mechanical loads are also absorbed by the attachment to the glass cover and in the installation space here. For example, owing to the printed circuit boards being fixed to the glass cover in the longitudinal direction (X direction), unintentional release of the connection in this direction is thus not possible, and for this reason the requirements made of such mechanical structures which mutually lock the printed circuit boards, in particular prevent the movement in the X direction, and which are present in the resilient latching in the plug-in connector according to the exemplary embodiments may well turn out to be somewhat lower. Therefore, latching with space is also possible.

It has also been described above that the latching with space in the X direction allows limited deviations in the mutual orientation of the connection parts in the XY plane. Furthermore, the space in the X direction also allows a tolerance for the gap size between the end-face edges of the printed circuit boards. One reason to require such tolerances (rotation and translation) is firstly that the position of the prisms may deviate slightly due to the accuracy of the manufacturing process. The prisms may be adhesively bonded on the pane, for example in strips. The mounting accuracy can then be compensated between the individual strips. Secondly, the strips should be able to be used universally. This means that the angle between the two end surfaces may differ from LED strip pair to LED strip pair. According to the invention, these differences should be compensated by the proposed plug-in connector with a joining direction perpendicular to the printed circuit board plane or to the plane of the lower surface of the connection parts provided for soldering or the like. As a result, for example, a bent curve can be approximated by the nonetheless straight sections of the LED strips.

Owing to the connection parts, a joining process in the Z direction with simultaneous tolerance compensation of +/−0.5 mm in the X direction, +/−0.25 mm in the Y direction and rotation about an axis in the Z direction of 6° can be achieved overall, for example. This clearance permits versatile use and combination of the LED circuit boards with each other. The tolerances can be achieved by the elastically deformable spring arms. The cutouts (reference sign 72 below) and radii (R1 to R4) shown in the specific exemplary embodiments additionally reduce the deformation and thus the damage to the parts. Therefore, a larger tolerance window can be covered without damage to the parts.

According to one exemplary embodiment of the plug-in connector, the first contact sections of the first connection part are each formed by a projection, which is formed in the relevant first wall section, or a recess or depression, which is formed in said first wall section, while the second contact sections of the second connection part are each formed by a recess or depression or projection, which is formed in the relevant second wall section and provided so as to complement the first contact section lying opposite. In other words, a respective depression or recess in the other resiliently mounted wall section lies opposite a projection in one resiliently mounted wall section in the Y direction in order to achieve the latching-in interaction. One advantage is created, for example, by a contact area which is as large as possible in the contact section when the shapes are precisely complementary. Furthermore, owing to the inclined surfaces at the edge of the depression or the protrusion, a self-adjusting effect can be achieved because the wall sections move into the latched position under the spring pressure if the depression and the projection at least already partially overlap during the joining operation. The recess can be produced by being punched out, and the projection or the depression can be produced by deep-drawing, for example.

According to one development of the exemplary embodiment of the plug-in connector, a respective recess or depression has a first extent (L6) in the first direction (X direction) and the projection lying opposite respectively has a second extent (L&) in the first direction (X direction), wherein the first extent (L6) is greater than the second extent (L7). In addition or as an alternative, for that wall section of the wall sections in which the recess or depression is formed in an extended manner in the first direction (X direction), these each exhibit a first extent (L6) in the first direction (X direction) and respectively a third extent (h8) in the third direction (Z direction), wherein the first extent (L7) is greater than the third extent (h8), so that the recess or depression exhibits a shape that is elongate in the first direction (X direction). This represents a particularly simple implementation of the contact sections.

It should be noted that the contact section that is shorter in the X direction can, but does not have to, exhibit an extension which corresponds in the X direction and in the Z direction.

Furthermore, the projection is preferably formed on the side of the first wall section of the female first connection part and the recess or depression is preferably formed on the side of the second wall section of the male second connection part. As a result, joining in an inclined manner (deviation in the XY plane or rotation in the orientation) prevents a front end of the second wall section, when it is inserted between the first wall sections, from meeting sections of the spring arm of the first connection part which are situated further behind and damaging them. Rather, contact is then made with the projection and the corresponding spring arm is spread.

According to a further development, the first and the second resiliently mounted wall sections extend in the third direction (Z direction) and lie opposite each other in the second direction (Y direction). In the non-loaded state, the resiliently mounted wall sections therefore extend parallel to each other.

A further exemplary embodiment provides that, in order to form a U-shaped profile in the corresponding base section, in the first connection part, first side walls extend in the third direction (Z direction) on opposite sides of the first bottom wall. As an alternative or in addition, in the second connection part, second side walls can similarly also extend in the third direction (Z direction) on opposite sides of the second bottom wall. The U-shaped profile provides the respective base section with stability and the required stiffness to stresses in the Z direction which are exerted onto the following spring section, which generally projects in the Z direction, and transfer them to the base section as lever force.

An exemplary embodiment building on the above provides for the first spring section to have two first spring arms, which each extend from a corresponding one of the first side walls of the first base section, preferably in the X direction. In addition or as an alternative, allowance can be made for the second spring section to also have two second spring arms, which each extend from a corresponding one of the second side walls of the second base section, preferably in the X direction. The spring arms each allow resilient mounting of the wall sections with the contact sections. Since the spring arms extend from the side walls extending in the Z direction, they can continue this Z orientation in the X direction for example as far as the wall sections and are therefore likewise relatively stiff in the Z direction and can be relatively easily resiliently deflected in the Y direction.

A further exemplary embodiment building on the above provides for the resiliently mounted first wall sections to form a distal end of the first spring arms and to be connected to the first side walls via first, at least partially inwardly inclined wall sections. As an alternative or in addition, the resiliently mounted second wall sections can also form a distal end of the second spring arms and can be connected to the second side walls via second, at least partially inwardly inclined wall sections. The at least partially inwardly inclined wall sections may allow a smaller mutual spacing of the wall sections in the Y direction, while a large-area solder connection may be provided for the base section owing to the comparative extent in the Y direction, which may improve the stability of the fastening to the printed circuit board.

Furthermore, the at least partially inwardly inclined wall sections permit limited elasticity of the spring section in the Z direction. A force acting in the Z direction, for example onto the resiliently mounted wall sections at the distal end, can be transmitted specifically via the at least partially inwardly inclined wall sections to the side walls of the base section such that this force has an effect in the Y direction owing to a slight deformation of the side walls (outward if the force acts upward in the Z direction, inward if the force acts downward). However, during joining, a force acting in the Y direction, which pushes the side walls outward, is generally more dominant. In addition, the arm (spring element) of the female element protrudes in the Z direction on the relevant printed circuit board and therefore no large Z forces are introduced into the side wall.

A further exemplary embodiment provides for a height (h2) in the third direction (Z direction) of the first, at least partially inwardly inclined wall sections to be reduced in comparison to a height (h1) of the first side walls and in comparison to a height (h3) of the resiliently mounted first wall sections in the third direction (Z direction). As an alternative or in addition, a height (h7) in the third direction (Z direction) of the second, at least partially inwardly inclined wall sections can also be reduced in comparison to a height (h6) of the second side walls and in comparison to a height (h5) of the resiliently mounted second wall sections in the third direction (Z). This design leads to further enhanced elasticity of the spring arms in the Z direction (which is however still smaller than in the Y direction).

A further exemplary embodiment provides, in the first connection part, for a section of the bottom wall that is widened in the first direction (X direction) to be separated from a section of the relevant spring arm on the two sides lying opposite in the second direction (Y direction) by a respective incision in the bottom wall. Here, a distal end of the incision is preferably rounded with a radius of curvature (R2). The incisions on the two sides of the bottom wall extend the length of the spring arms in the X direction without changing the total length of the relevant connection part. As a result, the spring arms obtain more elasticity primarily in the Y direction. At the same time, the bottom wall and here in particular its bottom surface, which is used for example as a soldering area for connection to the surface of the respective printed circuit board, can obtain a greater length in the X direction and in particular forward in the direction of the spring arms as a result, so that a lever force acting in the Z direction can be effectively countered. Owing to the corresponding positioning of a front edge of the bottom wall, the lever arm is shortened to the rear in spite of the extension of the spring arms.

The preferable rounding with the radius of curvature, which can continuously terminate the end of the incision, takes into account the not inconsiderable local tension forces which act from the deflected spring arms onto the base section during joining. Maximum values for these tension forces may be reduced by this measure.

As an alternative or in addition, in the second connection part, a section of the bottom wall that is widened in the first direction (X direction) can be separated from a section of the relevant spring arm on the two sides lying opposite in the second direction (Y direction) by a respective incision in the bottom wall. Here too, a distal end of the incision is preferably rounded with a radius of curvature (R4). The advantages are the same as described above.

According to a further exemplary embodiment, provision can be made, in the case of the first connection part, for a width (b1), which is defined by the first side walls, of the first connection part in the second direction (Y direction) to be greater by a factor of 1.25 to 4.0 than a width (b2) defined by the first resiliently mounted wall sections. As an alternative or in addition, in the case of the second connection part, a width (b4), which is defined by the second side walls, of the second connection part in the second direction (Y direction) can be greater by a factor of 1.5 to 8.0 than a width (b3) defined by the second resiliently mounted wall sections.

According to a further exemplary embodiment, provision can be made, especially in the second connection part, for the two resiliently mounted first wall sections to be connected to each other by a third bottom wall, the lower surface of which preferably extends in the same plane as the lower surface of the second bottom wall. The third bottom wall is separated from the second bottom wall by a recess here.

The third bottom wall creates a U-shaped profile in the region of the second wall sections. This provides the distal end of the second spring arms with more stability, in particular during joining of the connection parts. Furthermore, the third bottom wall prevents incorrect insertion of the total of four wall sections one into the other during joining. On account of the third bottom wall being separated from the second bottom wall of the base section by a recess, the elasticity provided by the spring arms is at least partially retained. The wall sections forming the side walls of the U-profile are still resiliently mounted and can individually bend in the Y direction under the action of force about a boundary line with respect to the third bottom wall or be deflected in the Y direction together with the bottom wall.

The recess between the bottom walls further has the effect of a certain degree of elasticity of the spring arms in the Z direction being retained.

Since the second and the third bottom wall preferably extend in the same plane, arrangement on the printed circuit boards can be made possible for example, in the case of which the second bottom wall allows fastening (for example soldering) of the second connection part on the associated second printed circuit board, while the third bottom wall rests on the main surface area of the other, first printed circuit board during or after the joining operation. Consequently, vertical orientation of the two printed circuit boards in relation to each other during joining is made possible and in addition an end point for the joining of the second connection parts into the first connection part in the Z direction is realized.

A further exemplary embodiment provides, especially in the first connection part, for both a fourth extent (L4) of the first base section or the first bottom wall in the first direction (X direction) and also a fifth extent (L2) of the first spring section or the first spring arms in the first direction (X direction) to be greater than half a total length (L1) of the first connection part in the first direction (X direction).

Aspects of the invention also provide a printed circuit board assembly for a roof system of a vehicle, which comprises:
a first printed circuit board;
a second printed circuit board, which is arranged at the end face in relation to the first printed circuit board; and
a plug-in connector according to one of the preceding aspects or exemplary embodiments, wherein the first connection part is arranged on a first surface of the first printed circuit board and the second connection part is arranged on a second surface of the second printed circuit board, and the two connection parts are latched to each other by way of their respective resiliently mounted wall sections or contact sections.

Further aspects relate to a roof system of a vehicle, which comprises such a printed circuit board assembly.

Further advantages, features and details of the various aspects may be gathered from the claims, the following description of preferred embodiments and with reference to the drawings. In the figures, references which are the same denote features and functions which are the same.

In accordance with one exemplary embodiment, the connection parts of the plug-in connection, in the state in which they are connected to each other, are configured to permit mutual rotation of the two printed circuit boards through an angle of 1° or more, preferably 2° or more, further preferably 5° or more, further preferably 10° or more, about at least one of the axes, without the connection being released by the rotation. Such rotations are possible in particular when the plug-in connection has elastic elements, which are suitable for defining a retaining force, in any case. The specified angles allow optimal spatial positioning of the connected printed circuit boards, for example in the roof system of a vehicle.

### BRIEF DESCRIPTION OF DRAWINGS

FIG. 1 shows a perspective view of a plug-in connector according to one exemplary embodiment, in a state in which it is mounted on respective printed circuit boards, which can form modules of an LED strip, and joined together;

FIG. 2 shows a side view of a first connection part (female, “socket”) of the plug-in connector from FIG. 1;

FIG. 3: shows a top view of the first connection part from FIG. 2;

FIG. 4 shows a side view of a second connection part (male, “plug”) of the plug-in connector from FIG. 1;

FIG. 5: shows a top view of the second connection part from FIG. 4;

FIG. 6: shows a cross-sectional view, in a plane (XZ plane) defined by the width and height directions, of the distal ends or wall sections of the connection parts inserted one into the other as in FIG. 1;

FIG. 7 shows the same as FIG. 6, but with schematically illustrated neutral positions of the wall sections without deflection, in overlap;

FIG. 8 shows a schematic illustration of a roof system of a motor vehicle having the printed circuit boards, which are connected by the plug-in connector according to FIGS. 1-7.

### DETAILED DESCRIPTION

In the following description of a preferred exemplary embodiment, it should be taken into consideration that the present disclosure of the various aspects is not limited to the details of the structure and the arrangement of the components, as presented in the following description and in the figures. All of the exemplary embodiments, including those not shown in the figures, may be implemented or executed in various ways. It should further be taken into consideration that the expressions and terminology used here are used for the purpose of specific description only, and they should not be construed as such in a limiting manner by those skilled in the art. Furthermore, in the following description, reference signs in the figures that are the same in the various exemplary embodiments or figures denote features or objects which are the same or similar, so that in some cases a repeated detailed description thereof is omitted in order to preserve the conciseness and clarity of the description.

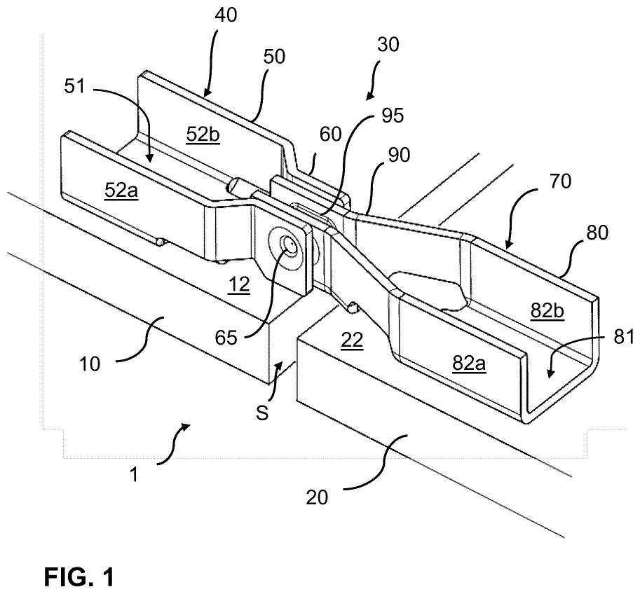

FIG. 1 shows a perspective view of a plug-in connector 30 according to one exemplary embodiment as part of a printed circuit board assembly 1. The plug-in connector 30 has a first connection part 40 and a second connection part 70. The first connection part 40 is female or formed as a socket and arranged on a first main surface area 12 of a first printed circuit board 10. The second connection part 70 is male or formed as a plug and arranged on a second main surface area 22 of a second printed circuit board 20. The printed circuit boards 10, 20 may be LED strips, without restricting the generality.

The first and second connection parts 40 and 70 are each formed from a flat metal piece which is appropriately cut in accordance with the shape and then bent or deep-drawn. The material of the flat metal piece may be a copper alloy. Contact and soldering areas may be coated with gold.

The first connection part 40 comprises a first base section 50 and also a first spring section 60. The first base section 50 has a substantially U-shaped profile in cross section. It is formed by a first bottom wall 51 and two side walls 52a, 52b which laterally adjoin the first bottom wall and lie opposite each other in a width direction (Y direction).

Similarly, the second connection part 70 comprises a second base section 80 and also a second spring section 90. The second base section 80 has a substantially U-shaped profile in cross section. It is formed by a second bottom wall 81 and two side walls 82a, 82b which laterally adjoin the second bottom wall and lie opposite each other in a width direction (Y direction). The two base sections 50, 80 are used, inter alia, to attach the corresponding connection part 40, 70 to the main surface areas 12, 22 of the corresponding printed circuit boards 10, 20.

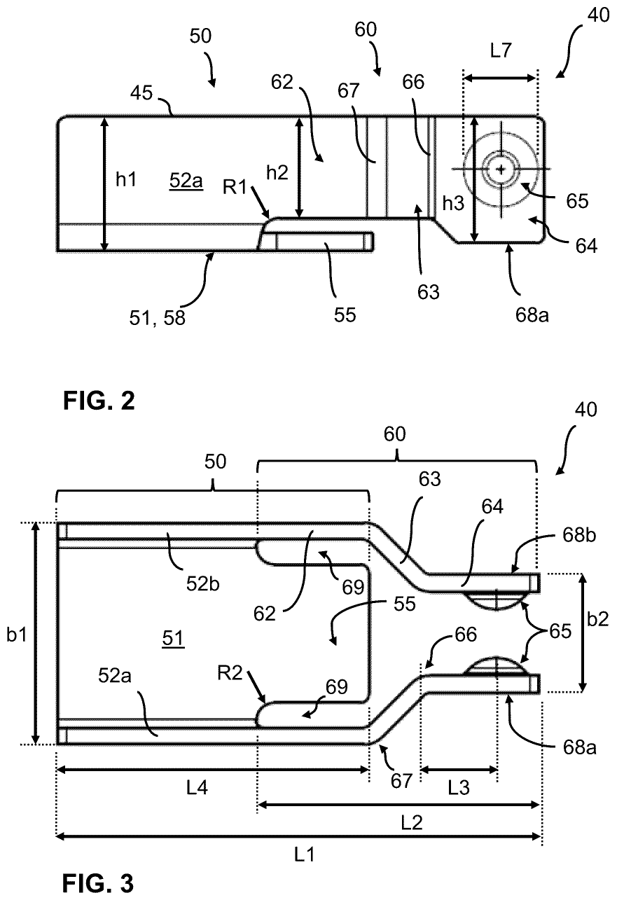

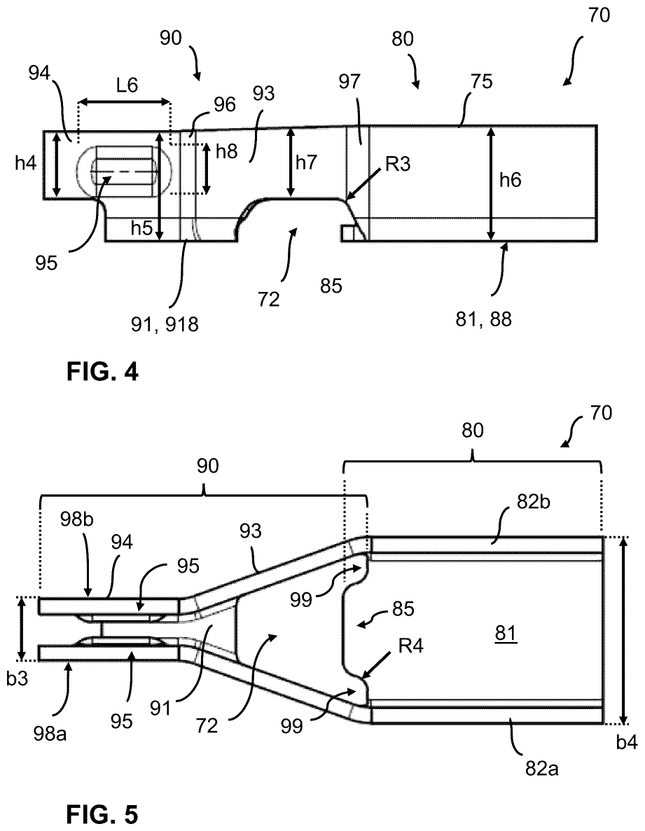

FIGS. 2 and 3 show a side view and a top view of the first connection part 40, while FIGS. 4 and 5 show a side view and a top view of the second connection part 70.

The first bottom wall 51 of the base section 50 of the first connection part 40 is substantially planar and has a lower surface 58, which, in order to establish an electrically conductive connection with a connection pad (not shown) on the first main surface area 12 of the first printed circuit board 10, is soldered to the first main surface area. Like the first main surface area 12, the lower surface 58 in this case defines a first direction (X direction) and a second direction (Y direction), which span the XY plane. Here, the first direction (X direction) is defined as the longitudinal direction of the printed circuit boards 10, 20 and the second direction (Y direction) is defined as the width direction of the printed circuit boards 10, 20. The mutually facing end faces or edges of the printed circuit boards 10, 20 extend in the width direction (Y direction). The first side walls 52a, 52b adjoin the bottom wall 51 on its two sides, but bent through 90°, in order to extend in a plane perpendicular to the XY plane. In particular, the side walls 52a, 52b extend in a third direction perpendicular to the XY plane, the Z direction.

First spring arms 68a, 68b, which form the first spring section 60, extend from the first base section 50 in each case in an extension of the first side walls 52a, 52b in the X direction. Here, the first spring arms 68a, 68b comprise, starting from the first side walls 52a, 52b, wall sections 62 which continue the side walls in the Y direction, and furthermore first inwardly inclined sections 63 and also resiliently mounted first wall sections 64 adjoining the inwardly inclined sections. The resiliently mounted first wall sections 64 form a distal end of the respective spring arms 68a, 68b. The first side walls 52a, 52b, the wall sections 62 which continue the first side walls, and the resiliently mounted wall sections 64 each extend parallel to each other and lie opposite each other in the Y direction. The first inwardly inclined sections 63 are inclined through approximately 45° in relation to the adjacent wall sections 62, 64. The wall sections 62, 63, 64 are divided by corresponding bending sections 66, 67. A top edge 45 of the first side walls 52a, 52b and also of the first spring arms 68a, 68b is of equal height over all sections. The overall height h1 of the first connection part 40 measured from the lower surface 58 to the top edge 45 is, for example, between 1.0 and 1.9 mm. The corresponding overall height h6 (see FIG. 4) of the second connection part 70 is preferably identical.

Owing to the first inwardly inclined sections 63, the resiliently mounted first wall sections 64 are relatively closely opposite each other. In the non-loaded inoperative state of the spring arms 68a, 68b, a width b2 measured in the width direction (Y direction) in the region of these first wall sections 64 is considerably smaller than a width b1 measured in the same direction in the base section 50.

The wall sections 62 which continue the side walls 52a, 52b and also the inwardly inclined wall sections 63 adjoining said wall sections are removed in their vertically lower region, so that their height h2 is smaller than the overall height h1 but also smaller than a height h3 of the resiliently mounted first wall sections 64. As a result, a certain degree of elasticity in the Z direction is obtained in the spring arms 68a, 68b. Furthermore, the wall sections 62 which continue the side walls 52a, 52b are separated from the bottom wall 51 by incisions 69 made in the bottom wall and extending in the X direction, so that a section 55 which is widened in the X direction or projects forward is formed in the bottom wall 51. In order to prevent local tension maxima at the end of the incisions 69, the incisions are rounded with a radius of curvature R2. The same applies to a rear corner of the recesses in the lower region of the wall sections 62, 63, see radius of curvature R1.

Owing to this design, a center of gravity of the first connection part 40 in the top view (XY plane) lies in the region of the bottom wall 51. The center of gravity therefore lies in the soldering area, so that positioning during mounting on the printed circuit board can be controlled more effectively and more exact positioning of the parts can be achieved overall. Owing to the geometry supported on the first main surface area 12 with the aid of the widened section 55 of the bottom wall 51, a latching force of contact sections formed in the wall sections 64 can be overcome without problems, so that the first connection part 40 is not permanently deformed. In addition, tilting of the parts during the soldering process is prevented as a result.

Owing to the described design, the base section 50 exhibits a length L4 in the X direction, which length overlaps with the length L2 of the spring arms 68a, 68b of the spring section 60. In the exemplary embodiment, both the length L4 and the length L2 are more than half the total length L1 of the first connection part 40.

The mutually opposite resiliently mounted first wall sections 64 each exhibit first contact sections 65, which are formed as projections on the inside, that is to say facing each other. As viewed from the outside, the wall sections 64 accordingly have depressions, these not playing any role, however. The projections lie opposite each other in exactly the same position in the Y direction. The spacing L3 between the center point of the respective projection and the closest bending section 66 measured in the X direction is chosen to be as small as possible, for example equal to or smaller than a length L7 (or the diameter) of the projection in the X direction. In the first connection part 40, the projections or first contact sections 65 can be rotationally symmetrical.

The second connection part 70 has a fundamentally similar design. The second bottom wall 81 of the second base section 80 is substantially planar and exhibits a lower surface 88 which, in order to establish an electrically conductive connection with a connection pad (not shown) on the second main surface area 12 of the first printed circuit board 10, is soldered to the first main surface area, for example. Like the second main surface area 12, the lower surface 88 in this case defines a first direction (X direction) and a second direction (Y direction), which span the XY plane. Since the printed circuit boards 10 and 20 or at least their end-face regions generally lie in a common plane, these directions between the first connection part 40 and the second connection part coincide. The second side walls 82a, 82b adjoin the bottom wall 81 on its two sides, but are bent through 90° here too, in order to extend in the third direction perpendicular to the XY plane, the Z direction.

Second spring arms 98a, 98b, which form the second spring section 90, extend from the second base section 80 in each case starting from the second side walls 82a, 82b (here however bending immediately inward) in the X direction. Here, the second spring arms 68a, 68b comprise, starting from the second side walls 82a, 82b here, second inwardly inclined sections 93 and also resiliently mounted second wall sections 94 adjoining the inwardly inclined sections. The resiliently mounted second wall sections 94 form a distal end of the respective spring arms 98a, 98b. The second side walls 82a, 82b and the resiliently mounted second wall sections 94 each extend parallel to each other and lie opposite each other in the Y direction. The second inwardly inclined sections 93 are inclined through approximately 30° in relation to the adjacent second wall sections 64 or second side walls 82a, 82b. The adjacent second wall sections 64 and the second side walls 82a, 82b are divided by corresponding bending sections 96, 97.

A top edge 75 of the second side walls 82a, 82b and also of the second spring arms 98a, 98b is no longer of equal height over all sections in the second connection part 70. The overall height h6 of the second connection part 70 measured from the lower surface 88 to the top edge 75 is, for example, between 1.0 and 1.9 mm. A corresponding overall height h5 (see FIG. 4) in a distal section of the second connection part 70 can be somewhat smaller.

Owing to the first inwardly inclined sections 93, the resiliently mounted second wall sections 94 are relatively closely opposite each other. In the non-loaded inoperative state of the spring arms 98a, 98b, a width b3 measured in the width direction (Y direction) in the region of these second wall sections 94 is considerably smaller than a width b4 measured in the same direction in the second base section 80.

Similarly to in the first connection part 40, in the second connection part 70, the inwardly inclined wall sections 63 which form spring arms 98a, 98b are removed in their vertically lower region, so that their height h7 is smaller than the overall height h1 but also smaller than a height h5 of the resiliently mounted second wall sections 94. As a result, a certain degree of elasticity in the Z direction is obtained in the spring arms 98a, 98b. Furthermore, the inwardly inclined wall sections 92 which continue the side walls 82a, 82b are also separated from the bottom wall 81 by incisions 99 made in the base wall and extending in the X direction here, even if not as distinctly as in the first connection part 40, so that a section 85 which is widened in the X direction or projects forward is formed in the bottom wall 81. In order to prevent local tension maxima at the end of the incisions 99, the incisions are rounded with a radius of curvature R4. The same applies to a rear corner of the recesses in the lower region of the wall sections 93, see radius of curvature R3. The reason for this design is the same as specified above.

However, in the second connection part 70, unlike in the first connection part 40, the resiliently mounted wall sections 94 are connected by a third bottom wall 91, see FIG. 5, and a length (not shown) of the spring section is considerably greater than in the first connection part. Owing to a lower surface 918 of the third bottom wall 91, the front region of the thus widely protruding spring arms 98a, 98b can come to lie on the first main surface area 12 of the first printed circuit board 10 lying opposite during joining, in order to assist the orientation and to simplify the joining process, cf. FIG. 1. The third bottom wall 91 is separated from the second bottom wall by a recess 72 in order to ensure the elasticity of the second spring section 90.

A further difference between the first connection part 40 and the second connection part 70 is a second contact section 95, which is formed as a depression in each of the resiliently mounted second wall sections 94 in the respectively outwardly facing surface (and as a projection on the rear side, this not playing any role here either, however).

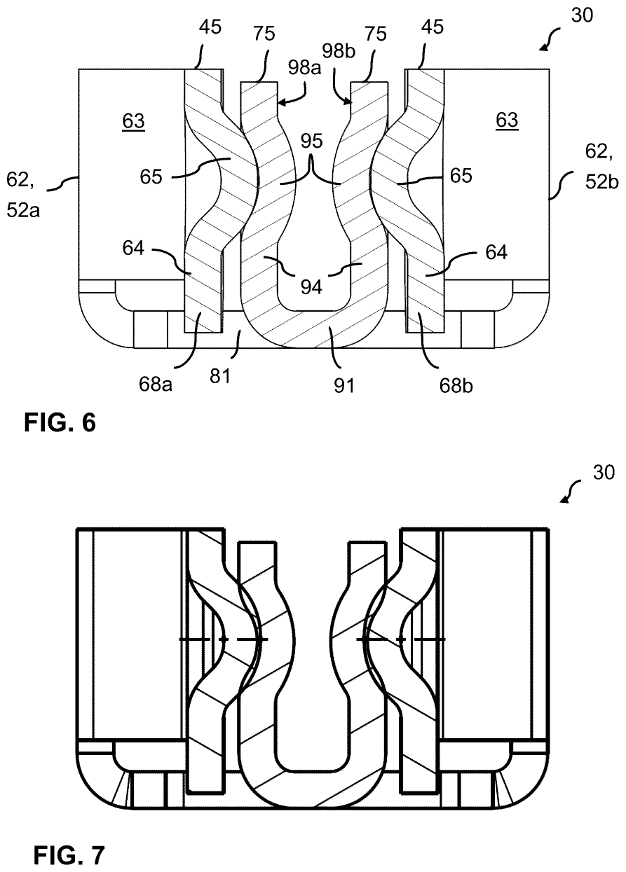

As can be seen in the cross section of FIG. 6, which shows the assembled first and second wall sections 64, 94, the second contact sections 95 are formed as depressions in the respectively outwardly directed surface of the second wall sections 94 and the first contact sections 65 are formed as projections in the inwardly directed surface of the first wall sections 64, the 3D shapes of the depressions and projections substantially corresponding, so that the mutual contact is made over as large a surface area as possible. The U-profile, which is formed by the second spring arms 98a, 98b and the third bottom wall 91, of the second spring section 90 of the second connection part 70 is joined between the first spring arms 68a, 68b of the first spring section 60 in the third direction (Z direction), that is to say from above in FIG. 6, in order to establish a mechanical and electrical connection.

Owing to a spring tension of the first and second spring arms 68a, 68b, 98a, 98b, the first contact sections 65 and the second contact sections 95 latch into each other when they are brought into contact (into overlap) with each other. FIG. 7 shows, in comparison to FIG. 6, a cross section in which the wall sections 64 and 94 are illustrated superimposed one on the other in their neutral positions.

However, as can be seen in FIG. 4, a length L6 of the second contact sections 95 in the X direction is considerably greater than the corresponding length L7 of the first contact sections 65 (cf. FIG. 2). In addition, the length L7 of the second contact sections 95 in the X direction is greater than a height h8 of the second contact sections in the third direction (the Z direction). That is to say, the second contact sections 95 are elongate in the X direction. Therefore, the first contact sections 65, which are shorter in the X direction, can exhibit, as projections, a small amount of space within the elongate depressions of the second contact sections 95. The gap S shown in FIG. 1 between the end-face edges of the printed circuit boards 10, 20 can therefore be liberally varied. This allows a tolerance for the mutual positioning of the two connection parts 40, 70. At the same time, the depression respectively extended in the X direction (second contact section 95) allows the recess to be quickly found by the projection (first contact section) correspondingly moving in the Z direction during joining.

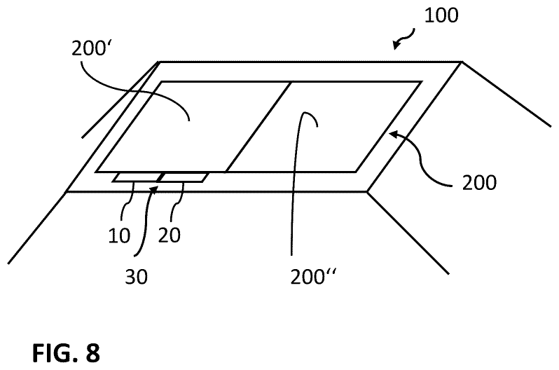

FIG. 8 shows a schematic illustration of a vehicle roof or roof system 100 of a motor vehicle that is otherwise not illustrated in any detail. The illustration shows a panoramic roof 200, which comprises a cover element 200′ fixedly installed in the frame or the body of the motor vehicle and also a cover element 200″ which can be adjusted therein. The two cover elements are embodied as vehicle panes. As an alternative, only one coherent, large cover element which occupies the area of the two cover elements with the glass panes (corresponding to the cover elements 200′ and 200″) can also be provided, this accordingly comprising only one vehicle pane and likewise being fixedly installed. However, as an alternative, an individual, coherent, adjustable cover element is also possible in principle. The panoramic roof 200 or the cover elements 200′, 200″ are held in a frame of the roof. Two strip-like printed circuit boards 10, 20, which are fitted with LEDs for example, are installed in the frame in such a way that they can couple the light emitted by the LEDs into the relevant cover element. The two printed circuit boards 10, 20 are further electrically and mechanically coupled to each other by the above-described plug-in connector 30.

It should be noted that the proposed plug-in connection is not restricted to the above-described specific application in the roof system of motor vehicles, but rather can also be used in particular in other situations in vehicles where little installation space is available, for example including in aircraft or ships, or else in buildings or technical installations which are immobile per se, etc. Use even in static environments such as living spaces or offices is not excluded.

### LIST OF REFERENCE SIGNS

1 Printed circuit board assembly
10 First printed circuit board
12 Main surface area (printed circuit board)
20 Second printed circuit board
22 Main surface area (printed circuit board)
30 Electrical plug-in connector (for example SMT)
40 First connection part (female element)
45 Upper edge of perpendicular (to the printed circuit board plane) walls
50 Base section (U-shaped), on the first connection part
51 First bottom wall
52a,b First side walls
55 Extended section of the first bottom wall
58 Lower surface of the first bottom wall (defines the XY plane)
60 Spring section, on the first connection part
62 Wall sections which continue side walls
63 First inwardly inclined wall sections
64 First resilient wall sections
65 First contact section (projection)
66 Bending section
67 Bending section
68a,b First spring arms
70 Second connection part (male element)
75 Upper edge of perpendicular (to the printed circuit board plane) walls
80 Base section (U-shaped), on the second connection part
81 Second bottom wall
82a,b Second side walls
85 Extended section of the second bottom wall
88 Lower surface of the second bottom wall (defines the XY plane)
90 Spring section, on the second connection part
91 Third bottom wall
93 Second inwardly inclined wall sections
94 Second resilient wall sections
95 Second contact section (recess)
96 Bending point
97 Bending point
98a,b Second spring arms
99 Lower surface of the third bottom wall (for example in the XY plane)
100 Roof system of the motor vehicle
200 Panoramic roof
200′, 200″ Cover elements
X Longitudinal direction, including of the printed circuit boards
Y Width direction, including of the printed circuit boards
Z Perpendicular to the printed circuit board plane (preferred joining direction)
b1-b4 Widths in the Y direction
h1-h8 Heights in the Z direction
L1-L6 Lengths in the X direction
R1-R4 Radii of curvature
S Gap

1. Plug-in connector for electrically connecting two printed circuit boards lying with their end faces opposite each other, comprising:
a first connection part and a second connection part, which mechanically interacts with the first connection part, for establishing the electrical connection;
wherein the first connection part comprises a first base section and a first spring section,
wherein the first base section has a first bottom wall with a first lower surface, which spans a plane, for attachment to a first main surface area of a first printed circuit board,
wherein the plane is defined by a first direction, in which the two printed circuit boards lie with their end faces opposite each other in the connected state, and a second direction, which is perpendicular to the first direction; and
wherein the first spring section comprises two resiliently mounted first wall sections lying opposite each other in the second direction;
wherein the second connection part comprises a second base section and a second spring section,
wherein the second base section has a second bottom wall with a second lower surface, which spans the same plane in the installed state, for attachment to a second main surface area of a first printed circuit board,
wherein the first spring section comprises two resiliently mounted second wall sections lying opposite each other in the second direction;
wherein the resiliently mounted first wall sections are configured to receive between them the resiliently mounted second wall sections along a third direction, which lies perpendicular to the plane;
wherein the first wall sections each comprise a first contact section and the second wall sections each comprise a second contact section, wherein a respective one of the first contact sections is designed to interact with a corresponding one of the second contact sections when the two connection parts are connected by mutual latching;
wherein the first contact sections and the second contact sections exhibit a different extent from each other in the first direction, so that contact defined by the contact sections in the latched-in state has space in the first direction.

2. Plug-in connector according to claim 1, wherein
the first contact sections are each formed by a projection, which is formed in the relevant first wall section, or a recess or depression, which is formed in said first wall section, and
the second contact sections are each formed by a recess or depression or projection, which is formed in the relevant second wall section and provided so as to complement the first contact section lying opposite.

3. Plug-in connector according to claim 2, wherein
a respective recess or depression has a first extent in the first direction and the projection lying opposite respectively has a second extent in the first direction, wherein the first extent is greater than the second extent; and/or
a respective recess or depression respectively exhibits a first extent in the first direction and respectively a third extent in the third direction, wherein the first extent is greater than the third extent, so that the recess or depression exhibits a shape that is elongate in the first direction.

4. Plug-in connector according to claim 1, wherein
the first and the second resiliently mounted wall sections extend in the third direction and lie opposite each other in the second direction.

5. Plug-in connector according to claim 1, wherein, in order to form a U-shaped profile,
in the first connection part, first side walls extend in the third direction on opposite sides of the first bottom wall; and/or
in the second connection part, second side walls extend in the third direction on opposite sides of the second bottom wall.

6. Plug-in connector according to claim 5, wherein
the first spring section has two first spring arms, which each extend from a corresponding one of the first side walls of the first base section, and/or wherein
the second spring section has two second spring arms, which each extend from a corresponding one of the second side walls of the second base section.

7. Plug-in connector according to claim 6, wherein
the resiliently mounted first wall sections form a distal end of the first spring arms and are connected to the first side walls via first, at least partially inwardly inclined wall sections; and/or
the resiliently mounted second wall sections form a distal end of the second spring arms and are connected to the second side walls via second, at least partially inwardly inclined wall sections.

8. Plug-in connector according to claim 7, wherein
a height in the third direction of the first, at least partially inwardly inclined wall sections is reduced in comparison to a height of the first side walls and in comparison to a height of the resiliently mounted first wall sections in the third direction; and/or
a height in the third direction of the second, at least partially inwardly inclined wall sections is reduced in comparison to a height of the second side walls and in comparison to a height of the resiliently mounted second wall sections in the third direction.

9. Plug-in connector according to claim 6, wherein
a section of the bottom wall that is widened in the first direction is separated from a section of the relevant spring arm on the two sides lying opposite in the second direction by a respective incision in the bottom wall, and/or
a section of the bottom wall that is widened in the first direction is separated from a section of the relevant spring arm on the two sides lying opposite in the second direction by a respective incision in the bottom wall.

10. Plug-in connector according to claim 5, wherein
a width, which is defined by the first side walls, of the first connection part in the second direction is greater by a factor of 1.25 to 4.0 than a width defined by the first resiliently mounted wall sections; and/or,
in the case of the second connection part, a width, which is defined by the second side walls, of the second connection part in the second direction is greater by a factor of 1.5 to 8.0 than a width defined by the second resiliently mounted wall sections.

11. Plug-in connector according to claim 1, wherein,
in the second connection part, the two resiliently mounted first wall sections are connected to each other by a third bottom wall; and
wherein the third bottom wall is separated from the second bottom wall by a recess.

12. Plug-in connector according to claim 1, wherein,
in the first connection part, both a fourth extent of the first base section or the first bottom wall in the first direction and also a fifth extent of the first spring section or the first spring arms in the first direction is greater than half a total length of the first connection part in the first direction.

13. Printed circuit board assembly for a roof system of a vehicle, comprising
a first printed circuit board;
a second printed circuit board, which is arranged at the end face in relation to the first printed circuit board; and
a plug-in connector according to claim 1, wherein the first connection part is arranged on a first surface of the first printed circuit board and the second connection part is arranged on a second surface of the second printed circuit board, and the two connection parts are latched to each other by way of their respective resiliently mounted wall sections or contact sections.

14. Roof system of a vehicle, comprising a printed circuit board assembly according to claim 13.

15. Plug-in connector according to claim 9, wherein
a distal end of the incision is rounded with a radius of curvature.

16. Plug-in connector according to claim 9, wherein
a distal end of the incision is rounded with a radius of curvature.

17. Plug-in connector according to claim 11, wherein,
the lower surface of the third bottom wall extends in the same plane as the lower surface of the second bottom wall.
